(19) United States
(12) Patent Application Publication
(10) Pub. No.: US 2025/0196602 A1
(43) Pub. Date: Jun. 19, 2025

(54) HEATED WINDSHIELD COVER DEVICE

(71) Applicant: David Tomaso, Hudson, NY (US)

(72) Inventor: David Tomaso, Hudson, NY (US)

(21) Appl. No.: 18/539,447

(22) Filed: Dec. 14, 2023

(51) Int. Cl. B60J 11/08

(52) U.S. Cl. CPC B60J 11/08

(57) ABSTRACT

A heated windshield cover device for inhibiting ice and snow from collecting on the windshield includes a cover having a front side coupled to a back side to define an interior space. The cover includes a rigid material and is configured to be positioned across a windshield of an automobile. A heating element is positioned within the interior space. A power source is electrically coupled to the heating element so that the heating element can produce heat when the power source is turned on. The heating element is arranged across the cover to produce heat across one or more of the front side and the back side of the cover.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to windshield covers and more particularly pertains to a new windshield cover for inhibiting ice and snow from collecting on the windshield.

### (2) Description of Related Art Including Information Disclosed Under 37 CFR 1.97 and 1.98

The prior art relates to windshield covers. The prior art discloses windshield covers that protect a vehicle from sun damage. Such windshield covers typically include a rigid visor that is positioned across an interior surface of the windshield to block sunlight when the vehicle is parked outdoors. The prior art also discloses windshield covers that are positioned on an exterior surface of the windshield to block the accumulation of ice and snow. The ice and snow thus collects on top of the windshield cover, which can be removed from the windshield before the vehicle is driven to expose a clear windshield. However, such covers are useless when placed inside the vehicle, and thus require the user to stand out in the cold, snowy weather to place the cover over the exterior surface of the windshield. Such windshield covers also require the user to store the wet, snowy cover in their vehicle between uses. If the weather is too cold, such covers may also freeze in place or be difficult to fold and store in the vehicle between uses. Thus, there is a need in the art for a windshield cover that can emit enough heat to inhibit snow and ice from accumulating across the windshield, and that can be positioned across an interior surface of the windshield so the user can position the cover while within the warm interior space of the vehicle.

### BRIEF SUMMARY OF THE INVENTION

An embodiment of the disclosure meets the needs presented above by generally comprising a cover having a front side coupled to a back side to define an interior space. The cover comprises a rigid material and is configured to be positioned across a windshield of an automobile. A heating element is positioned within the interior space. A power source is electrically coupled to the heating element whereby the heating element is configured to produce heat when the power source is turned on. The heating element is arranged across the cover whereby the heating element is configured to produce heat across one or more of the front side and the back side of the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a heated windshield cover device according to an embodiment of the disclosure.

FIG. 2 is an isometric view of an embodiment of the disclosure.

FIG. 3 is a front view of an embodiment of the disclosure.

FIG. 4 is a rear view of an embodiment of the disclosure.

FIG. 5 is a cross-sectional view of an embodiment of the disclosure.

FIG. 6 is an in-use view of an embodiment of the disclosure.

FIG. 7 is an in-use view of an embodiment of the disclosure.

FIG. 8 is an isometric view of an embodiment of the disclosure.

### DETAILED DESCRIPTION OF THE INVENTION

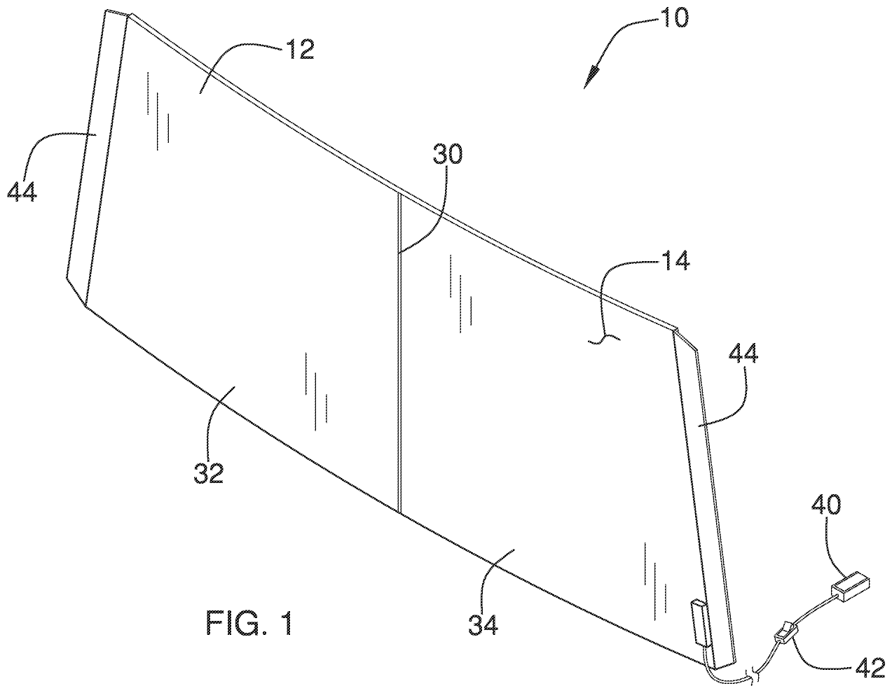

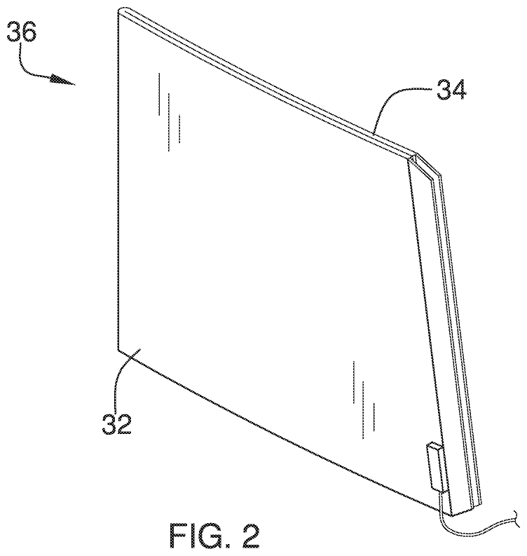

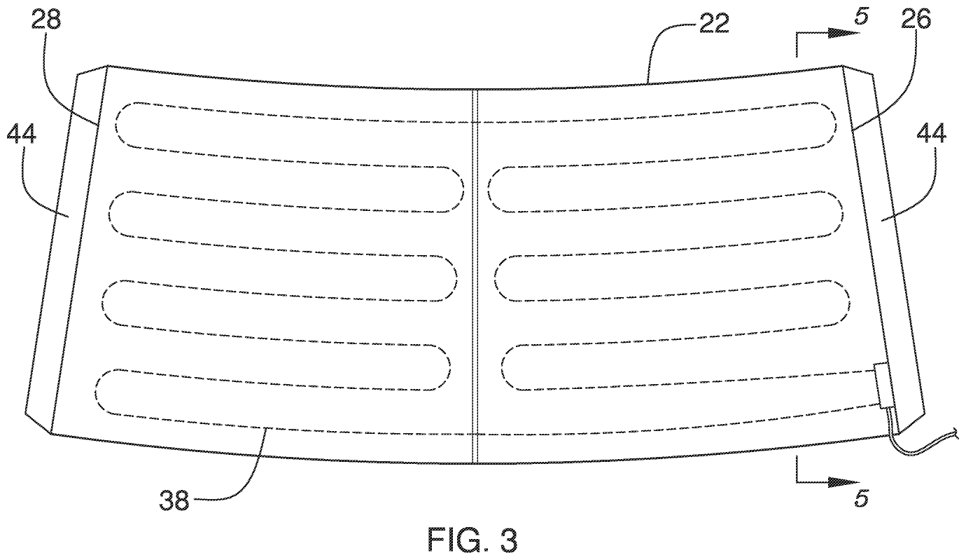

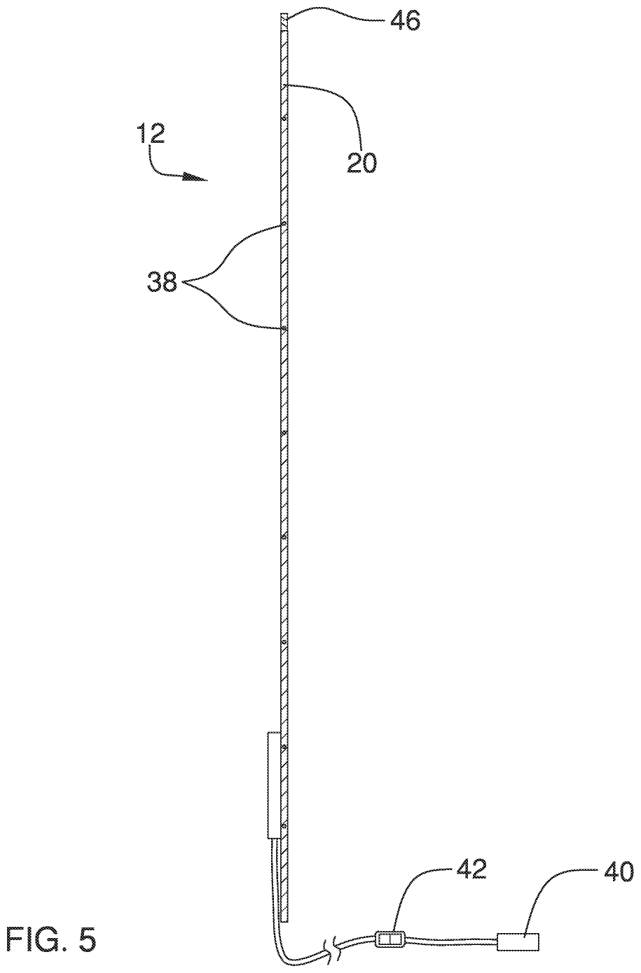

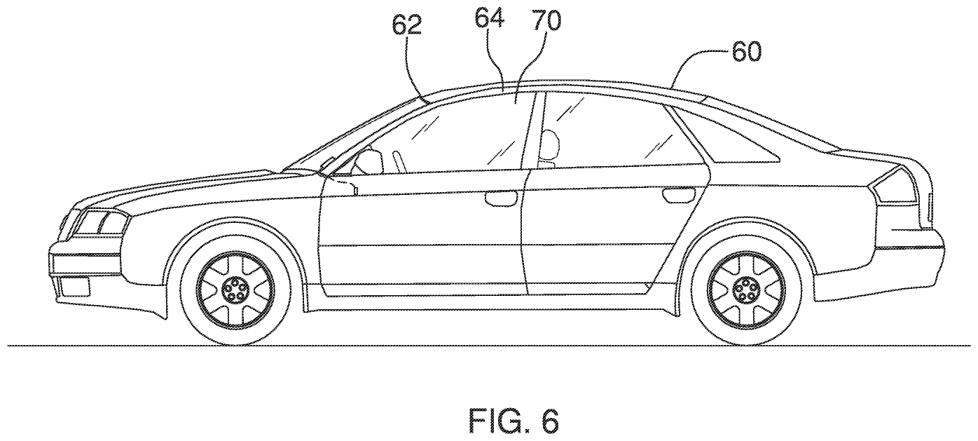

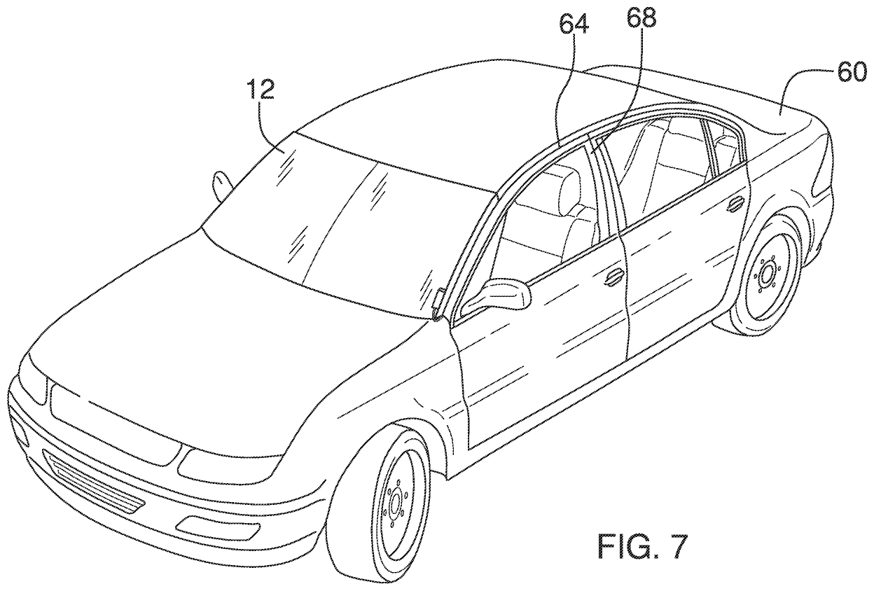

With reference now to the drawings, and in particular to FIGS. 1 through 8 thereof, a new windshield cover embodying the principles and concepts of an embodiment of the disclosure and generally designated by the reference numeral 10 will be described.

As best illustrated in FIGS. 1 through 8, the heated windshield cover device 10 generally comprises a cover 12 having a front side 14, a back side 16, and a perimeter edge 18 that is coupled to and extends between the front side 14 and the back side 16 to define an interior space 20. The perimeter edge 18 generally includes a top end 22, a bottom end 24, a first lateral end 26, and a second lateral end 28. The cover 12 is configured to be positioned across a windshield 62 of an automobile 60. For example, the cover 12 comprises a rigid material which may include one or more of an aluminum material and a plastic material.

The cover 12 may have a crease 30 that is within each of the front side 14 and the back side 16. The crease 30 may extend from the top end 22 to the bottom end 24 of the perimeter edge 18. The cover 12 is foldable along the crease 30 to define a folded configuration 36. For example, the crease 30 may be positioned midway between the first lateral end 26 and the second lateral end 28 to define a first half 32 and a second half 34 of the cover 12. The first half 32 and the second half 34 may pivot together to form the folded configuration 36.

A heating element 38 is positioned within the interior space 20 and may be coupled to the cover 12. In some embodiments, the heating element 38 comprises a wire.

A power source 40 is electrically coupled to the heating element 38 whereby the heating element 38 is configured to produce heat when the power source 40 is turned on. For example, the power source 40 may comprise a battery. A switch 42 may be electrically coupled to the power source 40 to selectively turn the power source 40 on and off.

The heating element 38 is arranged across the cover 12 whereby the heating element 38 is configured to produce heat across one or more of the front side 14 and the back side 16 of the cover 12 thereby inhibiting ice and snow buildup on the windshield 62 when the cover 12 is positioned across a surface of the windshield 62.

A pair of flaps 44 may be coupled to and extend outwardly from opposite sides of the perimeter edge 18, or opposite sides of the cover 12. The pair of flaps 44 is configured to facilitate securement of the cover 12 to the automobile 60. For example, the pair of flaps 44 may be positioned on a respective one of the first lateral end 26 and the second lateral end 28. Each of the pair of flaps 44 may comprise a flexible material, such as rubber, whereby each of the pair of flaps 44 is configured to be positioned between a frame 64 of the automobile 60 and a door element 66 of the automobile 60 when the cover 12 is positioned across the windshield 62 thereby inhibiting the cover 12 from falling off of the windshield 62. The door element 66 may comprise one of a door frame 68 and a window 70.

In some embodiments, each of the pair of flaps 44 may have a length that is coextensive with a length of the opposing lateral sides of the cover 12. In other words, each of the pair of flaps 44 may extend along a respective one of the first lateral end 26 and the second lateral end 28 from the top end 22 to the bottom end 24. An example of such embodiments is provided in FIG. 1.

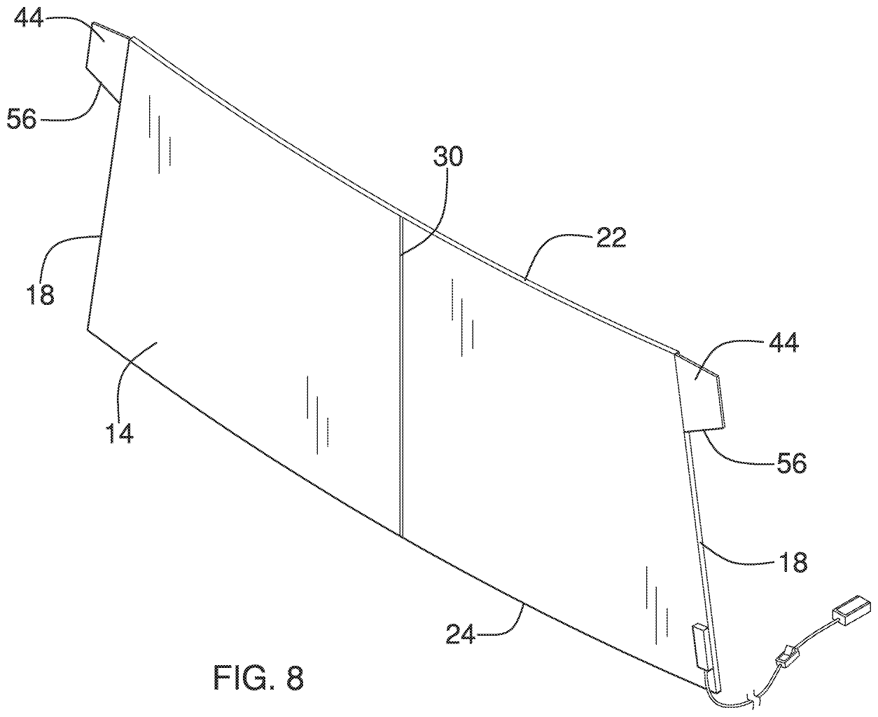

In other embodiments, each of the pair of flaps 44 may have a length that is shorter than a length of the opposing lateral sides of the cover 12. In other words, each of the pair of flaps 44 may extend downwardly along the respective one of the first lateral end 26 and the second lateral end 28 from the top end 22 whereby a lower edge 56 of each of the pair of flaps 44 is spaced from the bottom end 24 of the cover 12. An example of such embodiments is provided in FIG. 8.

An adhering panel 46 may be coupled to the cover 12. The adhering panel 46 may comprise a silicone material whereby the adhering panel 46 is configured to increase friction between the cover 12 and the windshield 62 thereby inhibiting the cover 12 from moving when the cover 12 is positioned across the windshield 62 of the automobile 60.

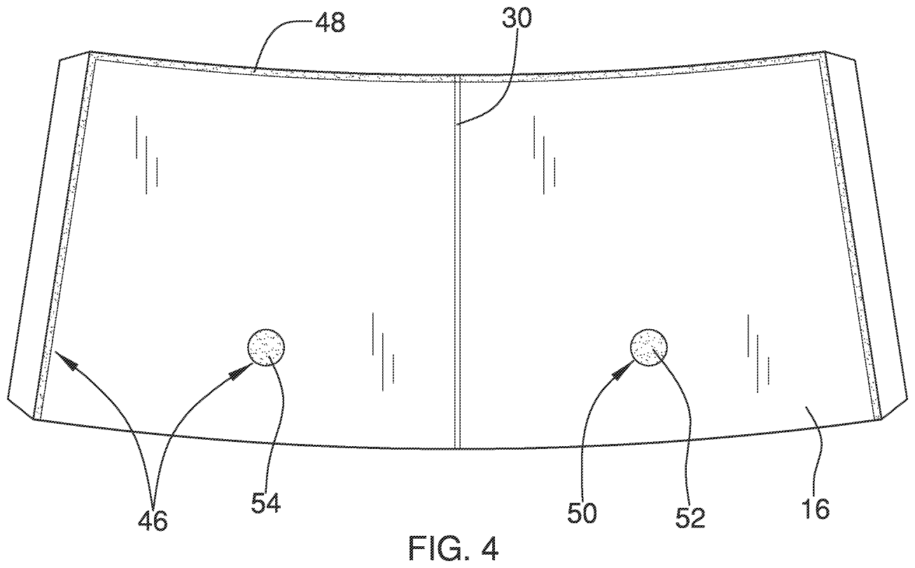

In some embodiments, the adhering panel 46 may comprise an adhering strip 48 that is coupled to the back side 16 of the cover 12. The adhering strip 48 may be positioned adjacent to one or more of the top end 22, the bottom end 24, the first lateral end 26, and the second lateral end 28 of the perimeter edge 18. In the example shown in FIG. 4, the adhering strip 48 has a rectangular shape.

Some embodiments of the adhering panel 46 may include an adhering pad 50 that is coupled to the back side 16 of the cover 12. The adhering pad 50 may be spaced from the perimeter edge 18 and may have a circular shape. For example, as shown in FIG. 4, the adhering pad 50 may include a first pad 52 that is positioned on the first half 32 and a second pad 54 that is spaced from the first pad 52 and positioned on the second half 34.

In use, the cover 12 can be positioned across the surface of the windshield 62. For example, the cover 12 can be positioned across an interior surface of the windshield 62 from within the cab of the automobile 60. Alternatively, the cover 12 may be positioned across the exterior surface of the windshield 62 from outside of the automobile 60. The back side 16 can be placed directly on the windshield 62 so that the adhering pad 50 contacts the back side 16 and helps to retain a position of the cover 12 relative to the windshield 62. The pair of flaps 44 can be positioned between the frame 64 and the door element 66 of the automobile 60 to secure the cover 12 to the automobile 60. Once the power source 40 is turned on, the heating element 38 can produce heat across the cover 12 to warm the surface of the windshield 62. For example, the heating element 38 may produce enough heat to warm the surface of the windshield 62 to between 35.0° Fahrenheit and 40.0° Fahrenheit, which is above the freezing temperature of water. The heated cover 12 can thus inhibit snow and ice from accumulating on the windshield 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automobile windshield cover assembly comprising:
a cover having a front side coupled to a back side to define an interior space, the cover comprising a rigid material, the cover being configured to be positioned across a windshield of an automobile;
a heating element being positioned within the interior space;
a power source being electrically coupled to the heating element whereby the heating element is configured to produce heat when the power source is turned on; and
wherein the heating element is arranged across the cover whereby the heating element is configured to produce heat across one or more of the front side and the back side of the cover.

2. The automobile windshield cover assembly of claim 1, the cover further comprising a perimeter edge being coupled to and extending between the front side and the back side, the perimeter edge including a top end, a bottom end, a first lateral end, and a second lateral end.

3. The automobile windshield cover assembly of claim 2, further comprising a crease being in each of the front side and the back side of the cover, the crease extending from the top end to the bottom end of the perimeter edge, the cover being foldable along the crease to define a folded configuration.

4. The automobile windshield cover assembly of claim 3, wherein the crease is positioned midway between the first lateral end and the second lateral end to define a first half and a second half of the cover, wherein the first half and the second half pivot together to form the folded configuration.

5. The automobile windshield cover assembly of claim 1, further comprising a pair of flaps being coupled to and extending outwardly from opposite sides of cover wherein the pair of flaps is configured to facilitate securement of the cover to the automobile.

6. The automobile windshield cover assembly of claim 5, wherein each of the pair of flaps is coextensive with a length of a respective one of the opposite sides of the cover.

7. The automobile windshield cover assembly of claim 5, wherein each of the pair of flaps extends downwardly from a top end of the cover along a respective one of the opposite sides whereby each of the pair of flaps is spaced from a bottom end of the cover.

8. The automobile windshield cover assembly of claim 5, each of the pair of flaps further comprising a flexible material whereby each of the pair of flaps is configured to be positioned between a frame of the automobile and a door element of the automobile when the cover is positioned across the windshield thereby inhibiting the cover from falling off of the windshield.

9. The automobile windshield cover assembly of claim 8, wherein the door element is one of a door frame and a window.

10. The automobile windshield cover assembly of claim 1, further comprising a switch being electrically coupled to the power source to selectively turn the power source on and off.

11. The automobile windshield cover assembly of claim 1, further comprising an adhering panel being coupled to the cover, the adhering panel comprising a silicone material whereby the adhering panel is configured to increase friction between the cover and the windshield thereby inhibiting the cover from moving when the cover is positioned across the windshield of the automobile,

12. The automobile windshield cover assembly of claim 11, the adhering panel further comprising an adhering strip being coupled to the back side of the cover, the adhering strip being positioned along an outer edge of the back side.

13. The automobile windshield cover assembly of claim 12, wherein the adhering strip has a rectangular shape.

14. The automobile windshield cover assembly of claim 11, the adhering panel further comprising an adhering pad being coupled to the back side of the cover, the adhering pad being spaced from an outer edge of the back side.

15. The automobile windshield cover assembly of claim 14, the adhering pad further comprising a first pad being spaced from a second pad.

16. The automobile windshield cover assembly of claim 14, wherein the adhering pad has a circular shape.

17. An automobile windshield cover assembly comprising:
a cover having a front side, a back side, and a perimeter edge being coupled to and extending between the front side and the back side to define an interior space, the perimeter edge including a top end, a bottom end, a first lateral end, and a second lateral end, the cover being configured to be positioned across a windshield of an automobile, the cover comprising a rigid material including one or more of an aluminum material and a plastic material;
the cover having a crease being in each of the front side and the back side, the crease extending from the top end to the bottom end of the perimeter edge, the crease being positioned midway between the first lateral end and the second lateral end to define a first half and a second half of the cover, the cover being foldable along the crease to define a folded configuration, wherein the first half and the second half pivot together to form the folded configuration;
a heating element being coupled to the cover, the heating element being positioned within the interior space, the heating element comprising a wire;
a power source being electrically coupled to the heating element whereby the heating element is configured to produce heat when the power source is turned on, the power source comprising a battery;
wherein the heating element is arranged across the cover whereby the heating element is configured to produce heat across one or more of the front side and the back side of the cover;
a switch being electrically coupled to the power source to selectively turn the power source on and off;
a pair of flaps being coupled to and extending outwardly from opposite sides of the perimeter edge wherein the pair of flaps is configured to facilitate securement of the cover to the automobile, each of the pair of flaps being positioned on a respective one of the first lateral end and the second lateral end, each of the pair of flaps comprising a rubber material whereby each of the pair of flaps is configured to be positioned between a frame of the automobile and a door element of the automobile when the cover is positioned across the windshield thereby inhibiting the cover from falling off of the windshield, wherein the door element is one of a door frame and a window;
an adhering panel being coupled to the cover, the adhering panel comprising a silicone material whereby the adhering panel is configured to increase friction between the cover and the windshield thereby inhibiting the cover from moving when the cover is positioned across the windshield of the automobile, the adhering panel comprising:
an adhering strip being coupled to the back side of the cover, the adhering strip being positioned adjacent to one or more of the top end, the first lateral end, and the second lateral end of the perimeter edge, the adhering strip having a rectangular shape; and
an adhering pad being coupled to the back side of the cover, the adhering pad being spaced from the perimeter edge, the adhering pad including a first pad being positioned on the first half and a second pad being positioned on the second half, the adhering pad having a circular shape.

18. The automobile windshield cover assembly of claim 17, wherein each of the pair of flaps extends from the top end to the bottom end.

19. The automobile windshield cover assembly of claim 17, wherein each of the pair of flaps extends downwardly from the top end along the respective one of the first lateral end and the second lateral end whereby each of the pair of flaps is spaced from the bottom end.
